(19) United States
(12) Patent Application Publication
(10) Pub. No.: US 2026/0369894 A1
(43) Pub. Date: Nov. 19, 2026

(54) CONFORMAL ANTENNA ASSEMBLIES FOR INCREASING LOW ELEVATION RADIATION

(71) Applicant: Harman International Industries, Incorporated, Stamford, CT (US)

(72) Inventors: Ho-Un Baek, Suwon-si (KR); Yong-Sun Shin, Suwon-si (KR); Sang-Bong Sung, Seongnam-si (KR); Jinu Kim, Seoul (KR); Hao Liu, Fremont, CA (US); Hao Xu, Shanghai (CN)

(21) Appl. No.: 19/755,517

(22) Filed: Jul. 27, 2026

Related U.S. Application Data
(63) Continuation of application No. 18/732,443, filed on Jun. 3, 2024.

(51) Int. Cl. H01Q 21/06; H01Q 1/32

(52) U.S. Cl. CPC H01Q 21/068; H01Q 1/3275

(57) ABSTRACT

Systems are provided for conformal antenna assemblies for increased low elevation radiation. The conformal antenna assembly includes a carrier of a base and a plurality of protrusions extending vertically therefrom, wherein the carrier is mounted on a printed circuit board (PCB), an antenna in face sharing contact with the base and electrically coupled to the PCB, a coupling plate spaced away from the antenna by the plurality of protrusions, and a switching system adapted to electrically couple the coupling plate to the PCB in a default mode or a switched mode.

### CROSS-REFERENCE TO RELATED APPLICATIONS

The present application is a continuation of U.S. Non-Provisional patent application Ser. No. 18/732,443, entitled “CONFORMAL ANTENNA ASSEMBLIES FOR INCREASING LOW ELEVATION RADIATION”, and filed on Jun. 30, 2024. The entire contents of the above-listed application are hereby incorporated by reference for all purposes.

### TECHNICAL FIELD

The present description relates generally to conformal antenna assemblies for increasing low elevation radiation.

### BACKGROUND AND SUMMARY

One or more antennae may be included in an antenna system of a telematics unit in a vehicle electronics system for wireless communication between the vehicle and external devices. The antenna system may be a sharkfin antenna system which extends vertically upwards from a roof of the vehicle, or a conformal antenna system which is mounted inside a roof of the vehicle such that the antenna system may be positioned within or underneath the roof.

Conformal antenna systems may have advantages over conventional sharkfin antenna systems. For example, sharkfin antenna systems may extend vertically from a roof of a vehicle and impose additional height of the vehicle, while conformal antenna systems may be positioned within the roof without extending vertically therefrom. Further, sharkfin antenna systems may have a narrow bandwidth of a low frequency band, while conformal antenna systems may have a wider bandwidth of the low frequency band. Further, conformal antenna systems may have lower resource demand and lower weight than sharkfin antenna systems. Further still, conformal antenna systems may be placed closer to a telematics control unit (TCU), thereby increasing quality of communication therebetween. However, radiation patterns produced by conformal antennae may be insufficient, especially at low elevation (e.g., below a threshold distance upwards from a ground on which the vehicle rests) due to the conformal antennae having smaller vertical height than sharkfin antennae.

Thus, embodiments are disclosed herein that solve at least some of the issues described above with a conformal antenna assembly, comprising: a carrier, the carrier comprising a base and a plurality of protrusions extending vertically therefrom, wherein the carrier is mounted on a printed circuit board (PCB); an antenna, the antenna in face sharing contact with the base, wherein the antenna is folded over a first edge of the carrier and electrically coupled to the PCB; a coupling plate, the coupling plate spaced away from the antenna by the plurality of protrusions, wherein the coupling plate is folded over a second edge of the carrier; and a switching system, the switching system adapted to couple the coupling plate to the PCB in a default mode with a first lumped element value or a switched mode with a second lumped element value lower than the first lumped element value, wherein a peak resonant frequency of the antenna is higher when the switching system is in the switched mode.

In this way, the low elevation radiation may be increased, thereby allowing the conformal antenna system to achieve a desired radiation pattern. The conformal antenna assembly disclosed herein may further have at least some of the advantages described above, including reduced vehicle height, lower weight, lower resource demand, closer proximity to the TCU, and wide bandwidth of low band.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The disclosure may be better understood from reading the following description of non-limiting embodiments, with reference to the attached drawings, wherein below:

FIG. 1 shows a schematic depicting an example inter-vehicle communications system in accordance with one or more embodiments of the present disclosure;

FIG. 2 shows an example of an antenna in accordance with one or more embodiments of the present disclosure;

FIG. 3 shows a first view of an example of an antenna system without a coupling plate;

FIG. 4 shows a second view of the antenna system without the coupling plate;

FIG. 5 shows a third view of the antenna system without the coupling plate;

FIG. 6 shows an example of a coupling plate in accordance with one or more embodiments of the present disclosure;

FIG. 7 shows a fourth view of a conformal antenna assembly including the coupling plate in accordance with one or more embodiments of the present disclosure;

FIG. 8 shows a fifth view of the conformal antenna assembly;

FIG. 9 shows a schematic of a switching system of a conformal antenna assembly in accordance with one or more embodiments of the present disclosure;

FIG. 10 shows an example of the switching system;

FIG. 11 shows the conformal antenna assembly on a printed circuit board in accordance with one or more embodiments of the present disclosure;

FIGS. 12A-12D show example radiation patterns for conformal antennae with and without a coupling plate;

FIGS. 13A and 13B show example radiation patterns for a sharkfin antenna and a conformal antenna, respectively;

FIGS. 14A and 14B show example efficiency and voltage standing wave ratio, respectively, over a range of frequencies for different modes of the switching system; and

FIG. 15 shows an example of a conformal antenna assembly according to one or more embodiments of the present disclosure embedded within a roof of a vehicle.

### DETAILED DESCRIPTION

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

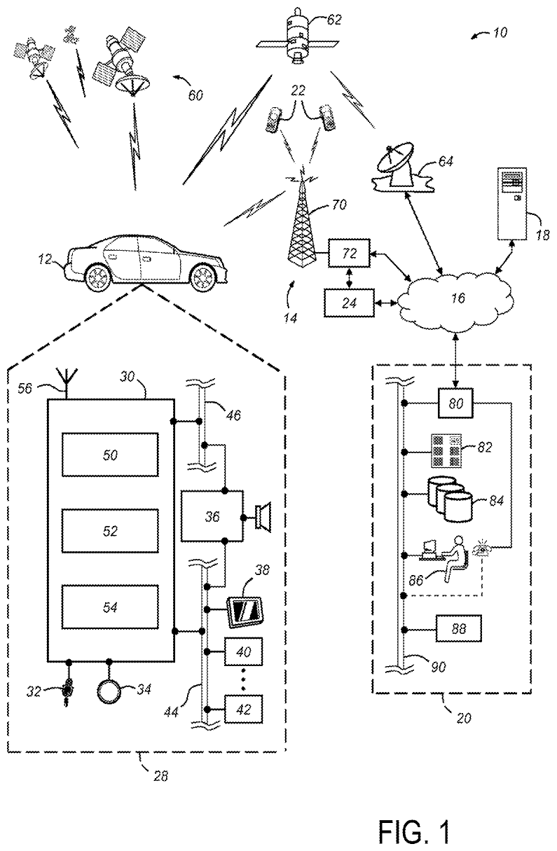

As described above, telematics systems are used to provide telecommunications and cellular connectivity for vehicles. The present disclosure describes an antenna assembly (e.g., a conformal antenna) which may be incorporated into a telematics system of a vehicle to establish communication between the vehicle and other vehicles in the same or similar geographic area or external services via a relay tower or base station. A communications system, such as the system depicted in FIG. 1, shows one such example of a system capable of providing communication between a vehicle and external services.

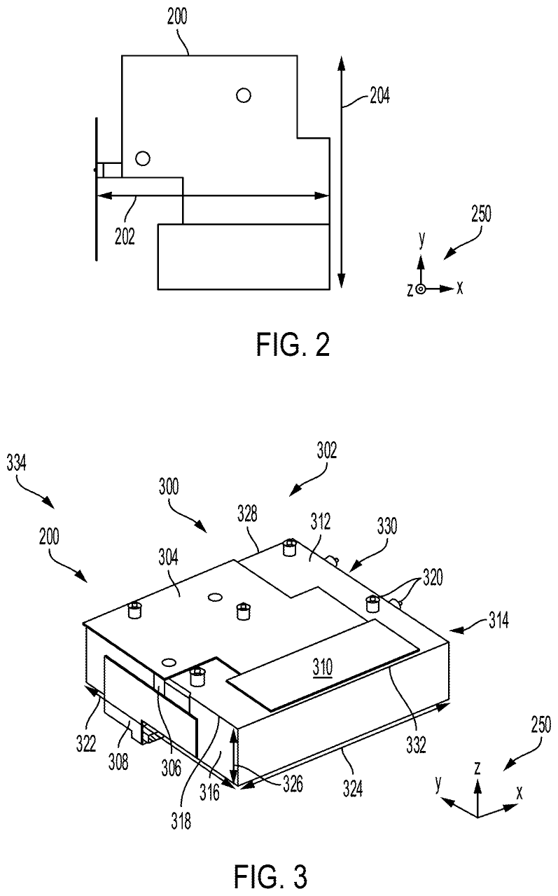

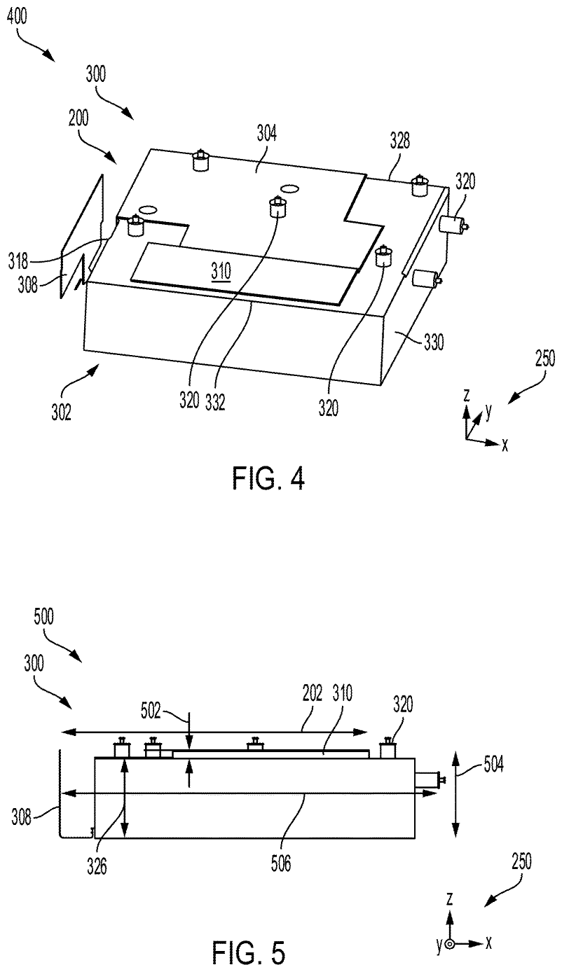

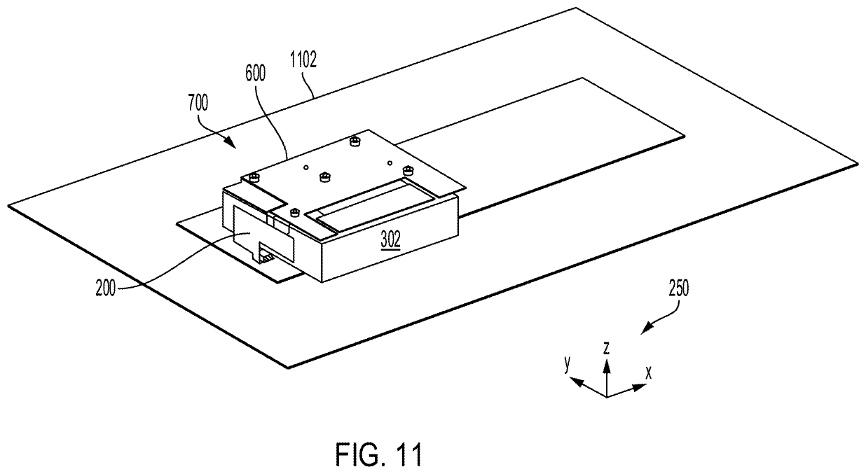

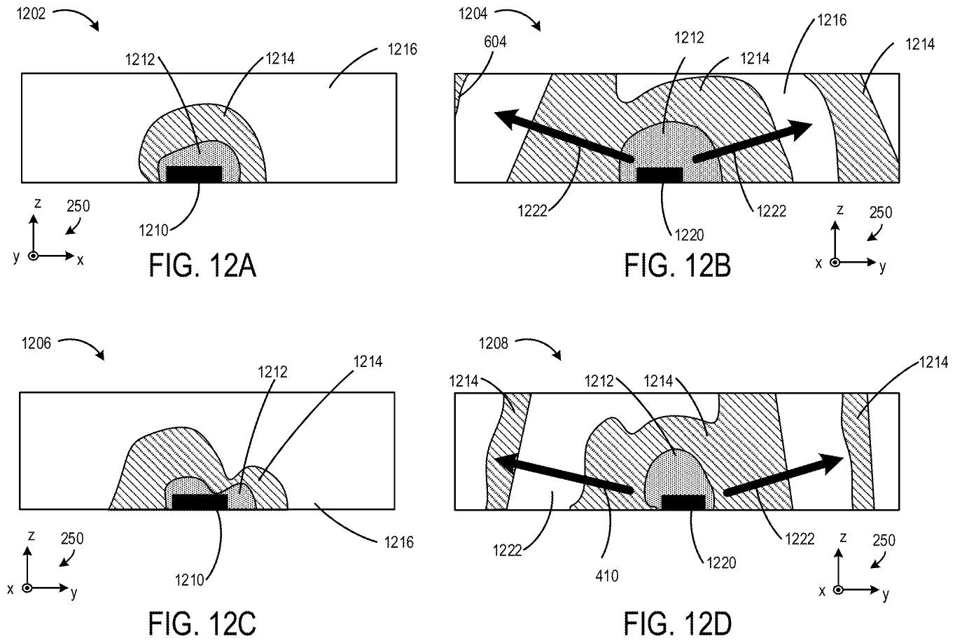

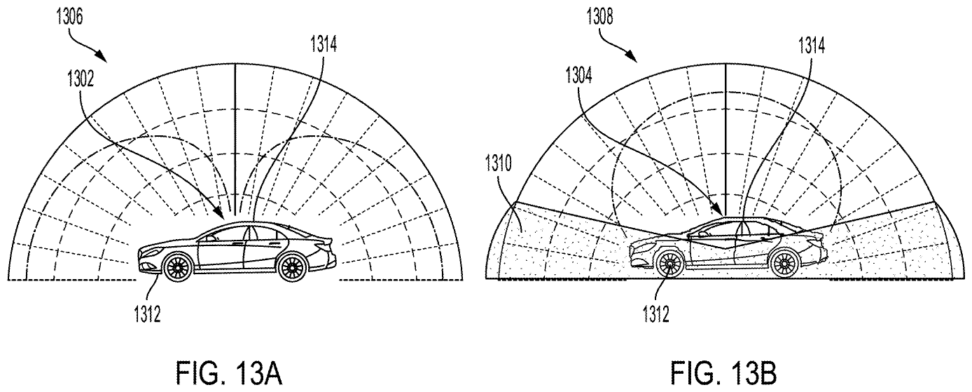

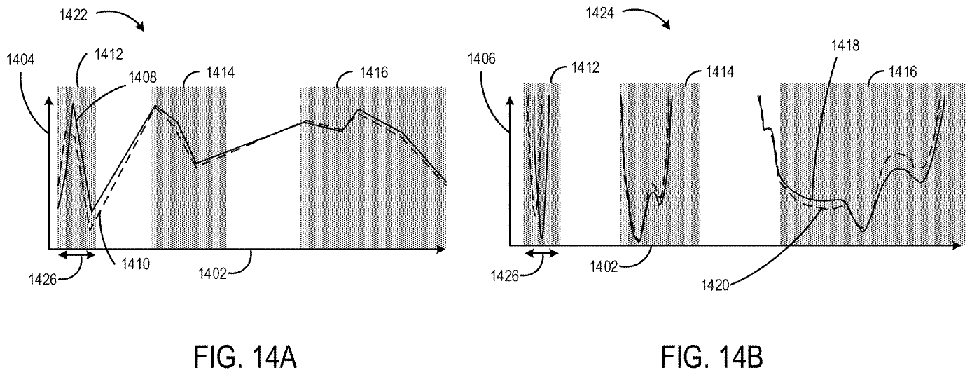

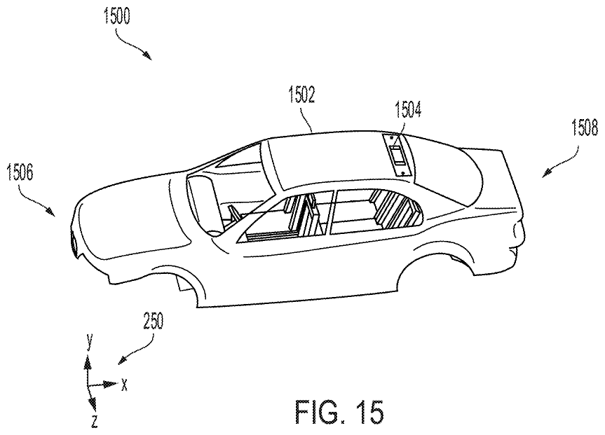

The antenna assembly disclosed herein may be a conformal antenna integrated inside the vehicle rather than being provided as a sharkfin antenna protruding from the roof of the vehicle. Further, rather than an external mounting position, the conformal antenna assembly may be mounted inside the roof of the vehicle, for example. In such an example, the conformal antenna assembly may be mounted (e.g., embedded) within a roof of the vehicle without protruding vertically therefrom such that the roof is continuous, as shown in FIG. 15. Such a position may reduce a vertical height of the antenna assembly, thereby reducing low elevation radiation therefrom. Example radiation patterns of a sharkfin antenna and a conformal antenna without coupling plate are provided in FIGS. 13A and 13B, respectively, to show that the conformal antenna without coupling plate produces less radiation at lower elevations (e.g., smaller distance from a ground on which the vehicle rests). Thus, the conformal antenna assembly disclosed herein may include a coupling plate and a switching system to increase radiation at lower elevations without compromising advantages of conformal antennae described above (e.g., without increasing a vertical height of the conformal antenna assembly). The switching system may change between a default mode and a switched mode to increase bandwidth of low band frequencies. FIGS. 14A and 14B show graphs of efficiency and voltage standing wave ratio (VSWR) for the default mode and switched mode over a range of frequencies, including low band, middle band, and high band frequencies. Further details as to the conformal antenna assembly of the present disclosure (e.g., with a coupling plate) are provided in regards to FIGS. 2-11 below. The conformal antenna assembly of the present disclosure is shown mounted on a PCB in FIG. 11, and positioned in a vehicle roof in FIGS. 13A and 13B. Example electromagnetic radiation patterns are shown in FIGS. 12A-12D for a conformal antenna without coupling plate and a conformal antenna with a coupling plate and switching system in accordance with one or more embodiments of the present disclosure to demonstrate an effect of the coupling plate and the switching system of the present disclosure may have in increasing radiation of the conformal antenna assembly.

With reference to FIG. 1, an exemplary operating environment is shown that comprises an inter-vehicle communications system 10 including one or more telematics-equipped vehicles 12, one or more wireless carrier systems 14, and one or more remote servers 16. In some examples, the inter-vehicle communications system 10 may additionally include various personal wireless devices 22. The following paragraphs simply provide a brief overview of one possible configuration for providing wireless communication between each of the vehicles 12, and between the vehicles 12 and remote servers 16. It should be appreciated that other systems not shown here may include the antenna assembly disclosed herein.

The vehicles 12 are depicted in the illustrated embodiment as passenger cars, but it should be appreciated that any other vehicle including motorcycles, trucks, sports utility vehicles (SUVs), recreational vehicles (RVs), marine vessels, aircraft, etc., can also be used. Some of the vehicle electronics 28 are shown generally in FIG. 1. The vehicle electronics 28 may include one or more of a telematics unit 30, a microphone 32, one or more pushbuttons or other control inputs 34, an audio system 36, a visual display 38, and a navigation module 40 as well as a number of vehicle system modules (VSMs) 42.

Telematics unit 30 may be an OEM-installed or aftermarket device that enables vehicles 12 to receive and/or transmit wireless signals corresponding to voice, text, and/or other data. Thus, telematics unit 30 may send and/or receive wireless signals (e.g., electromagnetic waves). Telematics unit 30 may therefore be referred to as transceiver 30, since it may be capable of both sending and receiving wireless signals. Wireless signals produced by the telematics unit 30 of vehicles 12 may be sent to and received by one or more of the vehicles 12 and remote servers 16. Thus, each of the vehicles 12 may be in wireless communication with one another for sending and/or receiving information there-between via the telematics unit 30. Further, each of the vehicles 12 may be in wireless communication with the remote servers 16 for sending and/or receiving information therebetween.

Wireless communication between the remote servers 16 and the vehicles 12 may be maintained even at greater distances between the remote servers 16 and the vehicles 12 by including relay towers 70. Each of the towers 70 may include sending and receiving antennae for relaying wireless signals between the remote servers 16 and the vehicles 12.

However, it should be appreciated that in some examples, relay towers 70 may not be included in the communications system 10, and that the vehicles 12 may be in direct wireless communication with the remote servers 16. Further, if one or more of the vehicles 12 are separated from the remote server 16 by a sufficient distance, and/or terrain (e.g., mountains) that blocks the wireless signal from being transmitted there-between, then the one or more vehicles 12 may not be in wireless communication with the remote servers 16.

Additionally or alternatively, communications system 10 may utilize satellite communications to provide uni-directional or bi-directional communication between one or more of the vehicles 12 and the remote servers 16 by using one or more communication satellites 62 and an uplink transmitting station 64.

As such, each of the vehicles 12 may communicate with one or more of remote servers 16, other telematics-equipped vehicles 12, or some other entity or device capable of transmitting and/or receiving wireless signals. Telematics unit 30 may enable the vehicle to offer a number of different services including those related to messaging, navigation, telephony, emergency assistance, diagnostics, infotainment, and so on.

According to one embodiment, telematics unit 30 utilizes a wireless modem 50 for data transmission, an electronic processor 52, one or more digital memory devices 54, and one or more antennae 56. Telematics unit 30 may further include an antenna heatsink according to the present disclosure as further described with reference to FIGS. 2, 4, and 7. It should be appreciated that the modem 50 can either be implemented through software or it can be a separate hardware component located internal or external to telematics unit 30. Wireless networking between the vehicles 12 and other networked devices can also be carried out using telematics unit 30. For this purpose, telematics unit 30 can be configured to communicate wirelessly according to one or more wireless protocols.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit 30 to provide a wide variety of services.

Telematics unit 30 can be used to provide a diverse range of vehicle services that involve wireless communication to and from the vehicles 12. Such services can include: remote control of certain vehicle features through the use of VSMs 42; turn-by-turn directions and other navigation-related services provided in conjunction with the navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the exemplary telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicles 12, to cite but a few possibilities. In the event that the modules are implemented as VSMs 42 located external to telematics unit 30, they could utilize communications bus 44 to exchange data and commands with the telematics unit 30.

Navigation module 40 may be configured to support any suitable navigation system. Navigation information can be presented on the display 38 (or other display within the vehicle) or can be presented verbally such as is done when supplying turn-by-turn navigation. The navigation services can be provided using a dedicated in-vehicle navigation module (which can be part of navigation module 40), or some or all navigation services can be done via telematics unit 30, wherein the position information is sent to a remote location for purposes of providing the vehicle with navigation maps, map annotations (points of interest, restaurants, etc.), route calculations, and the like.

Apart from the audio system 36 and navigation module 40, the vehicles 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests and perform other functions.

Vehicle electronics 28 may also include a number of vehicle user interfaces that provide vehicle occupants with a means of sending, displaying, and/or receiving information, such as microphone 32, pushbuttons(s) 34, audio system 36, and visual display 38. The pushbutton(s) 34 may allow manual user input into the telematics unit 30 to provide data, response, or control input. Various other vehicle user interfaces can also be utilized, as the interfaces of FIG. 1 are only an example of one particular implementation.

Remote servers 16 may include a logic subsystem 82 and a data-holding subsystem 84. Logic subsystem 82 may include one or more processors configured to execute software instructions. Such instructions may be implemented to perform a task, implement a data type, transform the state of one or more devices, or otherwise arrive at a desired result. Additionally or alternatively, the logic subsystem 82 may include one or more hardware or firmware logic machines configured to execute hardware or firmware instructions.

Data-holding subsystem 84 may include one or more physical, non-transitory devices configured to hold data and/or instructions executable by the logic subsystem 82 to implement methods and processes described herein. When such methods and processes are implemented, the state of data-holding subsystem 84 may be transformed (for example, to hold different data). Remote servers 16 may include one or more databases 85 in data-holding subsystem 84 for storing processed requests for assistance, vehicle location data, and vehicle operator preferences.

Remote servers 16 may optionally include a display subsystem 86, communication subsystem 88, and/or other components not shown in FIG. 2. For example, remote servers 16 may also optionally include user input devices such as keyboards, mice, game controllers, cameras, microphones, and/or touch screens. When included, display subsystem 86 may be used to present a visual representation of data held by data-holding subsystem 84 via one or more display devices. When included, communication subsystem 88 may be configured to communicatively couple remote servers 16 with one or more other computing devices, such as vehicles 12.

In some examples, the relay towers 70 may be configured as part of a wireless cellular network. In such examples, the communications system 10 may include personal wireless devices 22. For example, the personal wireless devices 22 may be cellular phones or other personal portable devices capable of wireless communication including, for the illustrated embodiment, SMS messaging capability. The devices 22 can communicate with the relay towers 70 to send and receive voice calls, SMS messages, and possibly other communications such as non-speech data for purposes of providing Internet access, weather information, stock information, etc. In general, SMS messages sent to or from the vehicles 12 or wireless mobile devices 22 are received and/or transmitted by the relay towers 70, and pass through one or more mobile switching centers 72 for processing and routing to the remote servers 16. Further, the telematics unit 30 of each of the vehicles 12 may be capable of sending and/or receiving SMS messages, and phone calls via the cellular network provided by the relay towers 70. As such, telematics unit 30 may utilize cellular communication and thus may include a cellular chipset for voice communications such as hands-free calling.

A conformal antenna assembly according to the present disclosure (e.g., the conformal antenna assembly 700 of FIGS. 7, 8, 10, and 11) including the one or more antennae 56 (e.g., the antenna 200 of FIGS. 2-8 and 10) may be mounted in (e.g., embedded within) a roof of a vehicle, such as the vehicles 12 shown in FIG. 1. The conformal antenna assembly may not protrude upwards from the roof of the vehicle. The conformal antenna assembly may emit electromagnetic radiation with a radiation pattern. As described above, previous examples of conformal antennae may produce inadequate radiation at low elevation levels.

Turning to FIG. 15, an example of an antenna assembly 1504 according to one or more example embodiments of the present disclosure (e.g., the conformal antenna assembly 700 of FIGS. 7, 8, and 11) is shown. The antenna assembly 1504 is positioned within a roof 1502 of a vehicle 1500. The roof 1502 may be a top of the vehicle 1500. The vehicle 1500 may be an example embodiment of a vehicle of the vehicles 12 of FIG. 1. The antenna assembly 1504 may be embedded within the roof 1502 such that the antenna assembly 1504 does not extend vertically from the roof 1502. As such, the antenna assembly 1504 may conform to the roof 1502 and hence be referred to as a conformal antenna assembly 1504. In other words, the roof 1502 may be continuous without disruption in an outer surface thereof (e.g., a surface of the roof 1502 facing a positive z-direction) due to a protruding and/or externally mounted antenna (e.g., a sharkfin antenna). In this way, a height (e.g., largest dimension parallel with the z-axis) of the vehicle 1500 may be reduced compared to a vehicle having an externally mounted and/or protruding antenna. In other examples, an antenna assembly of the present disclosure may be positioned in other locations of the roof 1502, such as closer to a front 1506 of the vehicle 1500, or closer to a rear 1508 of the vehicle. Further, the vehicle 1500, including the roof 1502, may take different shapes (e.g., size, proportions, curvature, etc.) than shown in FIG. 15 without departing from the scope of the present disclosure.

Turning to FIGS. 13A and 13B, examples are shown of radiation patterns for a first antenna 1302 and a second antenna 1304, respectively, when positioned on or in a roof 1314 of a vehicle 1312, such as described above with reference to FIG. 15. The first antenna 1302 may produce a first radiation pattern 1306 with higher levels of low elevation radiation, and the second antenna 1304 may produce a second radiation pattern 1308 with lower levels of low elevation radiation. As shown in comparing the first radiation pattern 1306 with the second radiation pattern 1308, the second antenna 1304 may produce less radiation in a low elevation area 1310 indicated in the figure by shading. The low elevation area 1310 may be defined as an area within a threshold vertical distance from the ground on which the vehicle 1312 is placed. The lower intensity (e.g., lack) of low elevation radiation produced by the second antenna 1304 may impede function of the antenna.

For example, the second antenna 1304 may be a conformal antenna without the coupling plate and switching system of the present disclosure (e.g., the carrier system 300 of FIG. 3), and the first antenna 1302 may be a sharkfin antenna or a conformal antenna with coupling plate and switching system according to the present disclosure (e.g., the conformal antenna assembly of FIGS. 7-11). The conformal assembly of the present disclosure with a coupling plate and switching system may produce a similar desired radiation pattern to a sharkfin antenna that is more effective than the radiation produced by a conformal antenna without the coupling plate and switching system of the present disclosure.

Turning to FIG. 2, an antenna 200 is shown. A set of reference axes 250 is provided, including an x-axis, a y-axis, and a z-axis. The reference axes 250 are further shown in FIGS. 3-12D to indicate relative orientations of the depicted components. For example, the z-axis may be a vertical axis approximately parallel with a direction of gravity. In such an example, the y-axis and x-axis may be lateral or horizontal axes approximately perpendicular to the direction of gravity. However, other orientations are possible without departing from the scope of this disclosure.

The antenna 200 is shown as a folded monopole antenna. However, the antenna 200 is exemplary and other antennae shapes and types (e.g., a planar inverted F antenna (PIFA)) may be included in a conformal antenna system in accordance with the present disclosure.

For the example shown in FIG. 2, the antenna 200 may be shaped as a conventional folded monopole antenna with an antenna width 202 and an antenna length 204

The antenna 200 may be folded over a carrier 302 as shown in a first view 334, a second view 400, and a third view 500 in FIGS. 3, 4, and 5, respectively, such that the antenna 200 is bent at an angle (e.g., approximately 90 degrees) along an edge 318 of the carrier 302. The carrier 302 and the antenna 200 may be referred to collectively as a carrier system 300. The carrier system 300 may also be referred to herein as an antenna assembly without coupling plate 600.

The carrier 302 may include a base with a plurality of protrusions 320 extending vertically from a top surface 312 and horizontally from a first side surface 314. The base may be rectangular prism shaped, in at least some examples. However, the base may also take other shapes according to a space wherein the carrier 302 is position. For example, the plurality of protrusions 320 may include a first plurality of protrusions extending vertically and a second plurality of protrusions extending laterally. At least some of the protrusions 320 may extend through the antenna 200. The antenna 200 may include a first portion 304 in face sharing contact with the top surface 312 of the carrier 302, a second portion 306 in face sharing contact with a second side surface 316 of the carrier 302, a third portion 308 extending from the second portion 306 and spaced away from the carrier 302, and a fourth portion 310 spaced away from (e.g., raised above by a distance 502) and parallel with the top surface 312. The fourth portion 310 may also be referred to as a raised portion. Each of the first portion 304, the second portion 306, the third portion 308, and the fourth portion 310 may be flat and roughly rectangular in shape, however as noted above, the antenna 200 may take a variety of shapes and sizes without departing from the scope of the present disclosure.

The carrier may have a carrier length 322, a carrier width 324, and a carrier height 326. The carrier system 300 may further have a carrier system height 504 which includes the vertical height of the protrusions 320 extending upwards. As used herein, a width may be a dimension parallel with the x-axis, a length may be a dimension parallel with the y-axis, and a height may be a dimension parallel with the z-axis. The carrier width 324 may be greater than or equal to the antenna width 202, and the carrier length 322 may be greater than or equal to the antenna length 204. In this way, the antenna 200 may not extend beyond a second edge 328, a third edge 330, or a fourth edge 332. In other examples, the dimensions of the carrier 302 may be different in value and/or relative values.

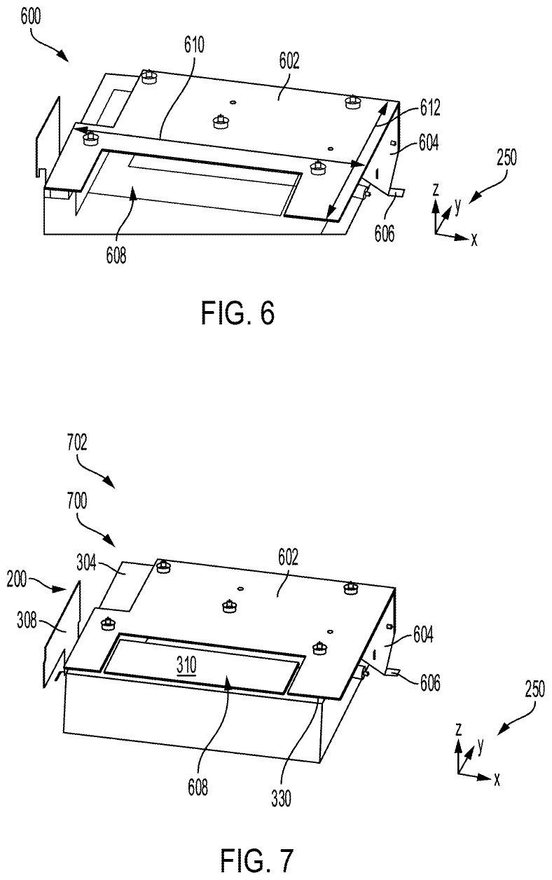

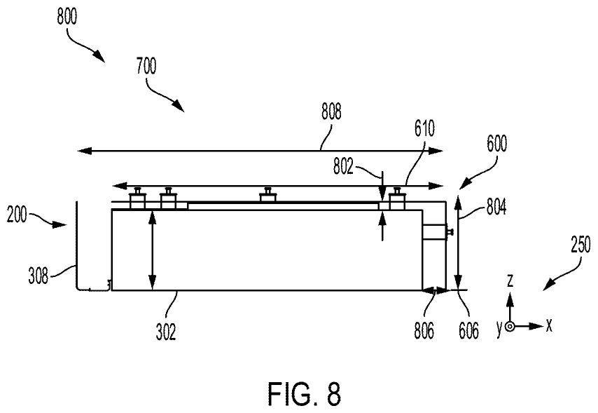

As described above, a conformal antenna system of the present disclosure may further include a coupling plate. An example of a coupling plate 600 is shown in FIG. 6. The carrier system 300 may include a coupling plate 600 to form a conformal antenna assembly 700 as shown in a sixth view 702 and a seventh view 800 in FIGS. 7 and 8, respectively. The coupling plate 600 may physically couple to the carrier 302.

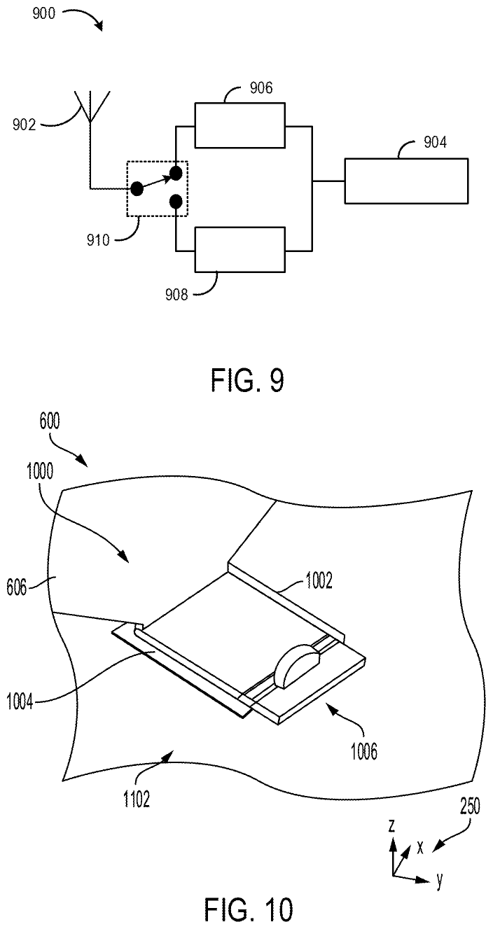

Referencing FIGS. 6-8 collectively, the coupling plate 600 may comprise a first portion 602 and a second portion 604, wherein the first portion 602 and the second portion 604 are flat surfaces approximately perpendicular to one another. The coupling plate 600 may further comprise a tab 606 which may be coupled to a switching system (e.g., the switching system 900 and 1000 of FIGS. 9 and 10, respectively) as described further below.

The coupling plate may have a coupling plate width 610 and a coupling plate length 612. The coupling plate width 610 may be greater than the carrier width 324 and the coupling plate length 612 may be greater than the carrier length 322. The coupling plate 600 may be folded over the edge 330 of the carrier 302, wherein the edge 330 is opposite from and parallel with the edge 318 over which the antenna 200 is folded. The coupling plate 600 may be folded over a different edge (e.g., adjacent to the edge 318) additionally or alternatively, such as the edge 328, the edge 332, or the edge 318 so long as the antenna 200 and the coupling plate 600 are not in face sharing contact. Further, the coupling plate 600 may be spaced away from the base of the carrier 302 from which the protrusions 320 extend. For example, at least a portion of the protrusions 320 extending laterally from the base may space the coupling plate 600 from a side of the base. Likewise, at least a portion of the protrusions 320 extending vertically may space the coupling plate 600 from the top surface 312.

The first portion 602 may be parallel with and spaced away from the first portion 304. In this way, at least a portion of each of the coupling plate 600 and the antenna 200 may be parallel with the top surface 312. Further, the antenna 200 may be interposed between the coupling plate 600 and the base of the carrier 302. A gap with height 802 may be maintained between the first portion 304 and the first portion 602 by the protrusions 320 (e.g., vertically extending protrusions). The coupling plate 600 may also include a rectangular cut out 608 from the first portion 602 with a size (e.g., a length and a width) larger than a second size (e.g., a second length and a second width) of the fourth portion 310. In this way, the antenna 200 and the coupling plate 600 may be spaced away from each other and may not be in face sharing contact at any point. Further, the fourth portion 310 may be positioned coplanar with the first portion 304.

The second portion 604 may extend downwards and parallel with a side of the carrier 302. The tab 606 may bend laterally outwards from the second portion 604 adjacent to a bottom of the carrier 302 away from the carrier by a distance 806. The tab 606 may be an interface for a switching system to couple thereto as described below.

The conformal antenna assembly 700 may have a height 804 and a width 808. The width 808 may be greater than the carrier system width 506 due to the tab 606 extending laterally by the distance 806. The conformal antenna assembly 700 may also have a length approximately equal to the coupling plate length 612. The height 804 and the carrier system height 504 may be approximately the same. Thus, the coupling plate 600 may not increase the carrier system height 504 when added to the carrier system 300. For example, a coupling plate height of the coupling plate 600 may be approximately the same as an antenna height of the antenna 200. Further, the coupling plate height and the antenna height may be less than or approximately equal to the carrier system height 504.

The conformal antenna assembly 700 may be coupled to a printed circuit board (PCB) such that the tab 606 is coupled with the PCB via the switching system. For example, turning to FIG. 11, the coupling plate 600 and the antenna 200 may be electrically coupled to a PCB 1102 with the carrier 302 mounted thereon. In this way, the antenna 200 may send and receive electrical signals to other components electrically coupled to the PCB 1102. The switching system may change a lumped element value at the connection point between the PCB 1102 and the coupling plate 600 to allow for wide bandwidth on low-band frequency. For example, because the presence of the coupling plate 600 may affect a resonant frequency of the antenna 200, the switching system may be used to adjust the effectiveness (e.g., increase efficiency, gain, etc.) of the antenna at an operational frequency (e.g., to increase bandwidth of low-band frequencies) by impedance matching.

Turning to FIG. 9, an example switching system 900 in accordance with one or more embodiments of the present disclosure is schematically depicted, wherein the switching system 900 may change a lumped element value between a coupling plate 902 (e.g., the coupling plate 600 of FIGS. 6-8 and 11) and a PCB ground 904 (e.g., ground of the PCB 1102). The switching system 900 may include a switch 910. The switch 910 may be controlled by a central processing unit (CPU) or a network access device (NAD) module electrically and communicatively coupled to the switch 910 according to a system on chip (SoC). For example, the switching system 900 may be implemented in a conformal antenna assembly in a vehicle (e.g., the vehicles 12 of FIG. 1 or the vehicle 1312 of FIGS. 13A and 13B) and a CPU or controller of the vehicle may contain instructions in memory thereof (e.g., non-volatile memory) that when executed control a position of the switch 910.

The switch 910 may be a single pole double throw switch, or any other form of switch suitable for the purpose of switching between a default mode with a first lumped element value 906 and a switched mode with a second lumped element value 908, wherein the first lumped element value 906 is greater than the second lumped element value 908. The first lumped element value 906 may be referred to as a default lumped element value or a high lumped element value. The second lumped element value may be referred to as a switched lumped element value or a low lumped element value. For example, the first lumped element value 906 may be approximately 100 picofarad (pF) and the second lumped element value 908 may be approximately 7 pF. However, other lumped element values may be used according to dimensions or shape of the antennae. For example, the first lumped element value 906 may be in a range of 50 -150 pF and the second lumped element value 908 may be in a range of 3-30 pF. The aforementioned examples are non-limiting and other numerical values for the first lumped element value 906 and the second lumped element value 908 are also within the scope of the present disclosure. The first lumped element value 906 may be a default lumped element value and the second lumped element value 908 may be used for certain frequencies (e.g., frequencies at which the second lumped element value 908 is results in higher gain of an antenna assembly in which the switching system is employed) in low and middle bands. The switching system 900 may receive a signal (e.g., from a CPU or NAD module) to switch between the default mode and the switched mode depending on which mode may perform better (e.g., emit stronger radiation or convert electromagnetic radiation to a stronger electric signal) at a given frequency, as described further below in regards to FIGS. 14A and 14B. In this way, the conformal antenna assembly 700 may act similarly to a coupled PIFA. For example, the antenna 200 may behave as a feeder and the coupling plate 600 may behave as a radiator.

Turning to FIG. 10, an example 1000 of the switching system 900 of FIG. 9 is shown. The switching system 1000 may include a switch 1006 (e.g., the switch 910 of FIG. 9) electrically coupling the coupling plate 600 to the PCB 1102 via either a first coupler 1002 or a second coupler 1004. The first coupler 1002 may have a lower lumped element value than the second coupler 1004 as described above with regards to FIG. 9.

By switching using the switch 1006, a peak resonant frequency of the antenna may be shifted higher when the switching system is in the switched mode. For example, the first coupler 1002 coupling the coupling plate 600 to the PCB 1102 may result in a higher peak resonant frequency. In this way, an increase in low elevation radiation may result from switching the switching system to the switched mode at appropriate frequencies (e.g., frequencies wherein a gain is greater in the switched mode than the default mode). Further, the low frequency band may be widened by the switching system 1000 changing lumped element values.

For example, turning to FIGS. 14A and 14B, a first graph 1422 and a second graph 1424 are shown of efficiency (e.g., power compared to an isotropic radiator in decibels (dB)) and voltage standing wave ratio (VSWR), respectively, for modes of a switching system (e.g., the switching systems 900 and 1000 of FIGS. 9 and 10, respectively) which couples a PCB (e.g., the PCB 1102 of FIGS. 11 and 9) and a coupling plate (e.g., the coupling plate 600 of FIGS. 6-8 and 10-11) of a conformal antenna assembly of the present disclosure (e.g., the conformal antenna assembly 700 of FIGS. 7, 8, and 11). A low band 1412, a medium band 1414, and a high band 1416 are marked in shaded areas in the first graph 1422 and the second graph 1424. The conformal antenna assembly may be a multiband antenna.

The first graph 1422 includes a first axis 1402 increasing in frequency in the direction indicated by the arrow of the first axis 1402 (e.g., from 500 MHz to 5000 MHz) and a second axis 1404 increasing in efficiency in the direction indicated by the arrow of the second axis 1404 (e.g., from −16 dB to 0 dB). A dashed line 1410 is shown for the switching system in a default mode (e.g., with higher lumped element value) and a solid line 1408 is shown for a switched mode (e.g., with lower lumped element value). As seen in the first graph 1422, the switched mode may be more efficient at some frequencies, especially in the low band 1412.

The second graph 1424 includes the first axis 1402 and a third axis 1406, wherein VSWR increases in the direction indicated by the arrow of the third axis 1406 (e.g., from 1 to 11). A dashed line 1420 is shown for the default mode, and a solid line 1418 is shown for the switching system in the switched mode. As shown in the low band 1412 on the second graph 1424, the peak resonant frequency (e.g., the local minimum in the low band 1412) is shifted to a higher frequency when the switching system is in the switched mode. Thus, a width 1426 of the low band 1412 frequency range may be increased with impedance matching accomplished by the switching system and coupling plate (e.g., in the conformal antenna assembly 700 of FIGS. 7, 8, 10, and 11), compared to a narrower low band of an antenna assembly without the switching system or ability to change to the switched mode (e.g., the carrier system 300 of FIGS. 3-5).

For example, a CPU adapted to control the switching system may switch the switching system to the switched mode at higher frequencies within the low band (e.g., frequencies with a smaller difference from the higher peak resonant frequency than the lower peak resonant frequency) to increase radiation. The CPU may switch the switching system to the default mode at other frequencies, wherein efficiency is higher and VSWR is lower for the default mode than the switched mode. In at least some examples, the default mode may be used within a first range of low band frequencies and the switched mode may be used within a second range of low band frequencies not overlapping the first range, and wherein the second range includes higher frequencies than the first range.

Turning to FIGS. 12A, 12B, 12C, and 12D, exemplary electromagnetic radiation patterns are depicted in a first plot 1202, a second plot 1204, a third plot 1206, and a fourth plot 1208, respectively. The first plot 1202 and the third plot 1206 show example electromagnetic radiation in a front view and a side view, respectively, for a conformal antenna without coupling plate 1210 (e.g., the carrier system 300 shown in FIGS. 3-5). The second plot 1204 and the fourth plot 1208 show example electromagnetic radiation in a front view and a side view, respectively, for a conformal antenna assembly 1220. The conformal antenna assembly 1220 is in accordance with one or more embodiments of the present disclosure (e.g., the conformal antenna assembly 700 of FIGS. 7, 8, and 11) which includes a coupling plate (e.g., the coupling plate 600 of FIG. 6) and a switching system (e.g., the switching systems 900 and 1000 of FIGS. 9 and 10, respectively). Although not shown in the FIGS. 12A-12D, the conformal antenna without coupling plate 1210 and the conformal antenna assembly 1220 may be electrically coupled to a PCB (e.g., the PCB 1102 of FIG. 11) and positioned in a telematics system (e.g., embedded in a roof of a vehicle such as the vehicles 12 of FIG. 1, the vehicle 1312 of FIGS. 13A and 13B, and the vehicle 1500 of FIG. 15).

The plots 1202, 1204, 1206, and 1208 each show at least one of each of a first shaded region 1212, a second shaded region 1214, and an unshaded region 1216. The first shaded regions 1212 may have an electromagnetic field strength above a first threshold. The second shaded regions 1214 may have an electromagnetic field strength below the first threshold (e.g., non-zero threshold) and above a second threshold (e.g., non-zero threshold), wherein the second threshold is less than the first threshold. The unshaded regions 1216 may have an electromagnetic field strength below both the first threshold and the second threshold. For example, the first threshold may be 80 V/m and the second threshold may be 20 V/m.

The electromagnetic radiation strength produced by the conformal antenna assembly 1220 may be greater than the conformal antenna without coupling plate 1210. For example, the first shaded regions 1212 and the second shaded regions 1214 surrounding the conformal antenna assembly 1220 have a greater volume than around the conformal antenna without coupling plate 1210 as indicated by arrows 1222 showing example directions of expansion of the first shaded regions 1212 and the second shaded regions 1214. In this way, the conformal antenna assembly 1220 may achieve increased low elevation radiation. For example, the conformal antenna without coupling plate may have a radiation pattern about a vehicle similar to the radiation pattern 1306 around the vehicle 1312 in FIG. 13A, and the conformal antenna assembly 1220 may have a radiation pattern around a vehicle similar to the radiation pattern 1308 about the vehicle 1312 in FIG. 13B.

The technical effect of the conformal antenna assembly with coupling plate and switching system disclosed herein is to increase radiation emitted by the conformal antenna assembly. For example, when the conformal antenna assembly is positioned in a vehicle, radiation may be increased in a low elevation area (e.g., at distances from the ground on which the vehicle rests below the conformal antenna assembly). In this way, the conformal antenna may perform (e.g., send and receive wireless signals) with increased efficiency and wider bandwidth of low band frequencies. Further, the conformal antenna assembly disclosed herein may be embedded within the roof without extending vertically therefrom, thereby reducing a height of the vehicle.

The disclosure also provides support for a conformal antenna assembly, comprising: a carrier, the carrier comprising a base and a plurality of protrusions extending vertically therefrom, wherein the carrier is mounted on a printed circuit board (PCB), an antenna, the antenna in face sharing contact with the base, wherein the antenna is folded over a first edge of the carrier and electrically coupled to the PCB, a coupling plate, the coupling plate spaced away from the antenna by the plurality of protrusions, wherein the coupling plate is folded over a second edge of the carrier, and a switching system adapted to couple the coupling plate to the PCB in a default mode with a first lumped element value or a switched mode with a second lumped element value lower than the first lumped element value, wherein a peak resonant frequency of the antenna is higher when the switching system is in the switched mode. In a first example of the system, an antenna height of the antenna and a coupling plate height of the coupling plate are approximately equal. In a second example of the system, optionally including the first example, a first portion of the antenna and a second portion of the coupling plate are parallel with a top surface of the carrier. In a third example of the system, optionally including one or both of the first and second examples, the antenna comprises a raised portion spaced away from a top surface of the carrier and the coupling plate comprises a cut out larger than the raised portion such that the raised portion is positioned coplanar and within the cut out without contacting the coupling plate. In a fourth example of the system, optionally including one or more or each of the first through third examples, an antenna height of the antenna and a coupling plate height of the coupling plate are both less than a carrier height of the carrier. In a fifth example of the system, optionally including one or more or each of the first through fourth examples, the coupling plate is spaced away from the base by the plurality of protrusions. In a sixth example of the system, optionally including one or more or each of the first through fifth examples, a height of the conformal antenna assembly does not extend upwards from a roof wherein the conformal antenna assembly is embedded. In a seventh example of the system, optionally including one or more or each of the first through sixth examples, the first edge is adjacent to or opposite from the second edge.

The disclosure also provides support for a conformal antenna assembly, comprising: a carrier mounted to a PCB, the carrier comprising a base, a first plurality of protrusions extending vertically therefrom, and a second plurality of protrusions extending laterally therefrom, an antenna, where the antenna is electrically coupled to the PCB and in face sharing contact with the base on a top surface and a first side, wherein the top surface and the first side are perpendicular to one another, and wherein at least one of the first plurality of protrusions extends through the antenna, a coupling plate, the coupling plate spaced away from the antenna by at least one of the first plurality of protrusions and spaced away from a second side of the base by at least one of the second plurality of protrusions, wherein the second side is parallel with and opposite from the first side, and a switching system including a single pole double throw switch adapted to electrically couple the coupling plate to the PCB via a first coupler or a second coupler, wherein a lumped element value via the first coupler is higher than the second coupler. In a first example of the system, a first height of the carrier is greater than a second height of the antenna and a third height of the coupling plate, and wherein a fourth height of the conformal antenna assembly is approximately the same as the first height. In a second example of the system, optionally including the first example, a portion of the antenna is interposed between the coupling plate and the top surface. In a third example of the system, optionally including one or both of the first and second examples, a gap is maintained between the coupling plate and the antenna. In a fourth example of the system, optionally including one or more or each of the first through third examples, the coupling plate comprises a first portion parallel with the top surface, a second portion perpendicular to the first portion, and a tab extending laterally from a bottom of the second portion, wherein the coupling plate is coupled to the switching system via the tab.

The disclosure also provides support for a vehicle, comprising: a conformal antenna assembly embedded in a roof of the vehicle, wherein the conformal antenna assembly comprises: a carrier mounted on a PCB, an antenna, where the antenna is in face sharing contact with the carrier and electrically coupled to the PCB, a coupling plate, where the coupling plate is coupled to the carrier and spaced away from the antenna such that the antenna is interposed between the coupling plate and the carrier, and a switching system adapted to electrically couple the coupling plate to the PCB in a default mode with a high lumped element value or a switched mode with a low lumped element value, and a central processing unit, where the central processing unit is communicatively coupled to the conformal antenna assembly with instructions stored on non-volatile memory, the instructions executable to send a signal to the switching system to change between the default mode and the switched mode. In a first example of the system, the default mode is used within a first range of low band frequencies and the switched mode is used within a second range of low band frequencies not overlapping the first range, and wherein the second range includes higher frequencies than the first range. In a second example of the system, optionally including the first example, the conformal antenna assembly is adapted to provide wireless communication between the vehicle and external devices. In a third example of the system, optionally including one or both of the first and second examples, the carrier comprises a base and a plurality of protrusions extending therefrom, and wherein the plurality of protrusions extend through the antenna and the coupling plate. In a fourth example of the system, optionally including one or more or each of the first through third examples, the antenna is folded over a first edge of the carrier and the coupling plate is folded over a second edge of the carrier such that at least a portion of each of the coupling plate and the antenna are parallel with a top surface of the carrier. In a fifth example of the system, optionally including one or more or each of the first through fourth examples, an antenna height of the antenna is approximately equal to a coupling plate height of the coupling plate. In a sixth example of the system, optionally including one or more or each of the first through fifth examples, the conformal antenna assembly does not protrude upwards from the roof of the vehicle.

FIGS. 1-8, 10-13B, and 15 show example configurations with relative positioning of the various components. FIGS. 2-8 and 10-11 are shown approximately to scale; though other relative dimensions may be used. As used herein, the terms “approximately” is construed to mean plus or minus five percent of the range unless otherwise specified. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A conformal antenna assembly, comprising:
a carrier mounted on a PCB;
an antenna in face sharing contact with the carrier, wherein the antenna is folded over a first edge of the carrier and is electrically coupled to the PCB;
a coupling plate coupled to the carrier and spaced away from the antenna such that the antenna is interposed between the coupling plate and the carrier, wherein the coupling plate is folded over a second edge of the carrier; and
a switching system adapted to electrically couple the coupling plate to the PCB in a default mode with a first lumped element value or in a switched mode with a second lumped element value, the first lumped element value higher than the second lumped element value.

2. The conformal antenna assembly of claim 1, wherein the carrier comprises a base and a plurality of protrusions extending vertically therefrom, and wherein the coupling plate is spaced away from the antenna by the plurality of protrusions.

3. The conformal antenna assembly of claim 2, wherein the plurality of protrusions extend through the antenna and the coupling plate.

4. The conformal antenna assembly of claim 1, wherein a peak resonant frequency of the antenna is higher when the switching system is in the switched mode relative to when the switching system is in the default mode.

5. The conformal antenna assembly of claim 1, wherein at least a portion of each of the coupling plate and the antenna are parallel with a top surface of the carrier.

6. The conformal antenna assembly of claim 1, wherein the default mode is used within a first range of low band frequencies and the switched mode is used within a second range of low band frequencies not overlapping the first range, and wherein the second range includes higher frequencies than the first range.

7. The conformal antenna assembly of claim 1, wherein the switching system comprises a switch adapted to electrically couple the coupling plate to the PCB via a first coupler when the switching system is in the default mode or via a second coupler when the switching system is in the switched mode.

8. The conformal antenna assembly of claim 1, wherein the first lumped element value is in a range of 50 to 150 picofarads (pF) and the second lumped element value is in a range of 3 to 30 pF.

9. A conformal antenna assembly, comprising:
a carrier mounted on a PCB;
an antenna in face sharing contact with the carrier, wherein the antenna is folded over a first edge of the carrier and is electrically coupled to the PCB;
a coupling plate coupled to the carrier and spaced away from the antenna such that the antenna is interposed between the coupling plate and the carrier, wherein the coupling plate is folded over a second edge of the carrier; and
a switching system adapted to electrically couple the coupling plate to the PCB in a default mode with a first lumped element value or in a switched mode with a second lumped element value, the first lumped element value higher than the second lumped element value, wherein a peak resonant frequency of the antenna is higher when the switching system is in the switched mode than when in the default mode, and wherein the default mode is used within a first range of low band frequencies and the switched mode is used within a second range of low band frequencies not overlapping the first range, and wherein the second range includes higher frequencies than the first range.

10. The conformal antenna assembly of claim 9, wherein the carrier comprises a base and a plurality of protrusions extending vertically therefrom, and wherein the coupling plate is spaced away from the antenna by the plurality of protrusions.

11. The conformal antenna assembly of claim 10, wherein the plurality of protrusions extend through the antenna and the coupling plate.

12. The conformal antenna assembly of claim 9, wherein at least a portion of each of the coupling plate and the antenna are parallel with a top surface of the carrier.

13. The conformal antenna assembly of claim 9, wherein the antenna comprises a raised portion spaced away from a top surface of the carrier, and wherein the coupling plate comprises a cut out larger than the raised portion such that the raised portion is positioned coplanar with and within the cut out without contacting the coupling plate.

14. The conformal antenna assembly of claim 9, wherein the coupling plate comprises a first portion parallel with a top surface of the carrier, a second portion perpendicular to the first portion, and a tab extending laterally from a bottom of the second portion, wherein the coupling plate is electrically coupled to the switching system via the tab.

15. A vehicle comprising a conformal antenna assembly, the conformal antenna assembly comprising:
a carrier mounted on a PCB;
an antenna in face sharing contact with the carrier, wherein the antenna is folded over a first edge of the carrier and is electrically coupled to the PCB;
a coupling plate coupled to the carrier and spaced away from the antenna such that the antenna is interposed between the coupling plate and the carrier, wherein the coupling plate is folded over a second edge of the carrier; and
a switching system adapted to electrically couple the coupling plate to the PCB in a default mode with a first lumped element value or in a switched mode with a second lumped element value, the first lumped element value higher than the second lumped element value.

16. The vehicle of claim 15, further comprising a central processing unit, where the central processing unit is communicatively coupled to the conformal antenna assembly and comprises instructions stored on non-volatile memory, the instructions executable to send a signal to the switching system to change between the default mode and the switched mode.

17. The vehicle of claim 16, wherein the switching system comprises a switch adapted to electrically couple the coupling plate to the PCB via a first coupler when the switching system is in the default mode or via a second coupler when the switching system is in the switched mode, and wherein the signal sent to the switching system to change between the default mode and the switched mode causes the switch to change positions.

18. The vehicle of claim 15, wherein a peak resonant frequency of the antenna is higher when the switching system is in the switched mode than when in the default mode, and wherein the default mode is used within a first range of low band frequencies and the switched mode is used within a second range of low band frequencies not overlapping the first range, and wherein the second range includes higher frequencies than the first range.

19. The vehicle of claim 15, wherein the carrier comprises a base and a plurality of protrusions extending vertically therefrom, wherein the coupling plate is spaced away from the antenna by the plurality of protrusions, and wherein the plurality of protrusions extend through the antenna and the coupling plate.

20. The vehicle of claim 15, wherein the vehicle is a motorcycle.
